(19) United States
(12) Patent Application Publication
(10) Pub. No.: US 2024/0134766 A1
(43) Pub. Date: Apr. 25, 2024

(54) SYSTEM AND METHOD FOR SERVICE LIFE MANAGEMENT USING ACCELERATION FACTOR

(71) Applicant: Dell Products L.P., Round Rock, TX (US)

(72) Inventors: Michael Mitsuo Toulouse, San Jose, CA (US); Tyler Baxter Duncan, Austin, TX (US)

(21) Appl. No.: 17/971,136

(22) Filed: Oct. 20, 2022

(51) Int. Cl. G06F 11/30; G01K 1/14

(52) U.S. Cl. CPC G06F 11/3058; G01K 1/14; G06F 11/3013

(57) ABSTRACT

A method for environmentally managing environmental conditions of an information handling system includes obtaining an ambient temperature of an environment proximate to the information handling system. The method also includes obtaining an ambient humidity of the environment, determining a component temperature of a component in the information handling system, and determining a component humidity of the component based on the component temperature, the ambient temperature, and the ambient humidity. Further, the method includes determining an acceleration factor for the component based on the component humidity and the component temperature, and performing an action from an action set based on the acceleration factor.

### BACKGROUND

As the value and use of information continues to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Use cases for information handling systems are causing progressively larger number of information handling systems to be disposed near each other. For example, rack mount systems utilize a rack structure to stack two or more chassis in an information handling system. Due to the changing uses of information handling systems, chassis therein may be modular allowing for continual partial upgrades to the information handling system. That is, an information handling system may be composed of multiple chassis that may be attached to each other to form the information handling systems. When the multiple chassis are attached, components of the information handling system disposed in each of the chassis may become operably connected to each other.

### SUMMARY

In one aspect, a method for environmentally managing environmental conditions of an information handling system in accordance with one or more embodiments of the invention includes obtaining an ambient temperature of an environment proximate to the information handling system; obtaining an ambient humidity of the environment; determining a component temperature of a component in the information handling system; determining a component humidity of the component based on the component temperature, the ambient temperature, and the ambient humidity; determining an acceleration factor for the component based on the component humidity and the component temperature; and performing an action from an action set based on the acceleration factor.

In one aspect, an information handling system in accordance with one or more embodiments of the invention includes a component, a first ambient sensor configured to measure an ambient temperature of an environment proximate to the information handling system, a second ambient sensor configured to measure an ambient humidity of the environment, a component sensor configured to measure a component temperature of the component, and a processor. The processor is programmed to obtain the ambient temperature from the first ambient sensor, obtain the ambient humidity from the second ambient sensor, determine a component temperature of the component, determine a component humidity of the component based on the component temperature, the ambient temperature, and the ambient humidity, determine an acceleration factor for the component based on the component humidity and the component temperature, and perform an action from an action set based on the acceleration factor.

In one aspect, a non-transitory computer readable medium includes computer readable program code, which when executed by a computer processor enables the computer processor to perform a method for managing environmental conditions of an information handling system. The method in accordance with one or more embodiments of the invention includes obtaining an ambient temperature of an environment proximate to the information handling system, obtaining an ambient humidity of the environment, determining a component temperature of a component in the information handling system, determining a component humidity of the component based on the component temperature, the ambient temperature, and the ambient humidity, determining an acceleration factor for the component based on the component humidity and the component temperature, and performing an action from an action set based on the acceleration factor.

Other aspects of the invention will be apparent from the following description and the appended claims.

### BRIEF DESCRIPTION OF DRAWINGS

FIG. 1.1 shows a diagram of an information handling system in accordance with one or more embodiments of the invention.

FIG. 1.2 shows a diagram of a building that includes information handling systems in accordance with one or more embodiments of the invention.

FIG. 1.3 shows a diagram of a chassis of an information handling system in accordance with one or more embodiments of the invention.

FIG. 2 shows a flowchart of a method of managing environmental conditions in accordance with one or more embodiments of the invention.

FIG. 3 shows a diagram of a computing device in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In the following description of the figures, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

In general, embodiments of the invention relate to systems, devices, and methods for managing components of an information handling system. An information handling system may be a system that provides computer implemented services. These services may include, for example, database services, electronic communication services, data storage services, etc.

To provide these services, the information handling system may include one or more computing devices. The computing devices may include any number of computing components that facilitate providing of the services of the information handling system. The computing components may include, for example, processors, memory modules, circuit cards that interconnect these components, etc.

During operation, these components may generate heat and require gas flows to maintain the temperatures of these components within nominal ranges. However, these temperatures, and the thermal cycling of changing temperatures may affect the useful life of components within the information handling system. In addition, the gases may carry moisture, which is commonly measured in two different ways: in terms of total moisture in the air, known as absolute humidity, or in terms of a percentage of the maximum amount the air can hold, known as relative humidity. The relative humidity may be determined at a certain location based on the temperature and total moisture in the gas at the location and affects the useful service life of components within the information handling system. For example, the temperature and relative humidity may be used to determine an acceleration factor, which is a measurement of how quickly a component is aging compared to known rate of aging. The known rate of aging may be determined, e.g., by testing the component under known temperature and humidity conditions.

Embodiments of the invention may provide methods and systems that monitor and manage the environmental conditions. Embodiments of the invention are able to determine an acceleration factor of one or more components in the information handling system. To manage the acceleration factor of components, the methods and systems may adjust the temperature and/or humidity of the environment in which the components reside. Further, the methods and systems may provide a notice to a user when the acceleration factor increases above a threshold value, thereby providing the user with enhanced knowledge of adjusting a maintenance schedule to the user's particular situation. Other actions may be taken based on the acceleration factor without departing from the invention.

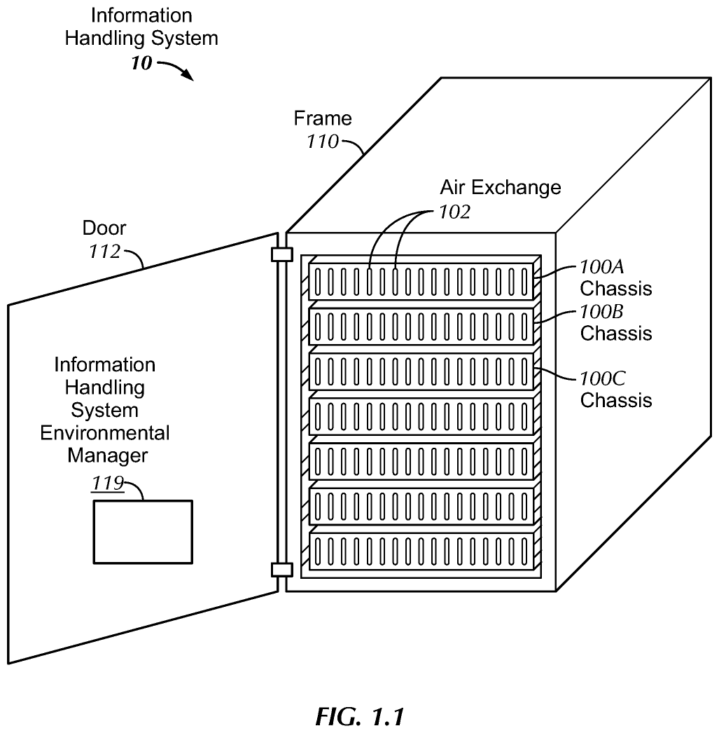

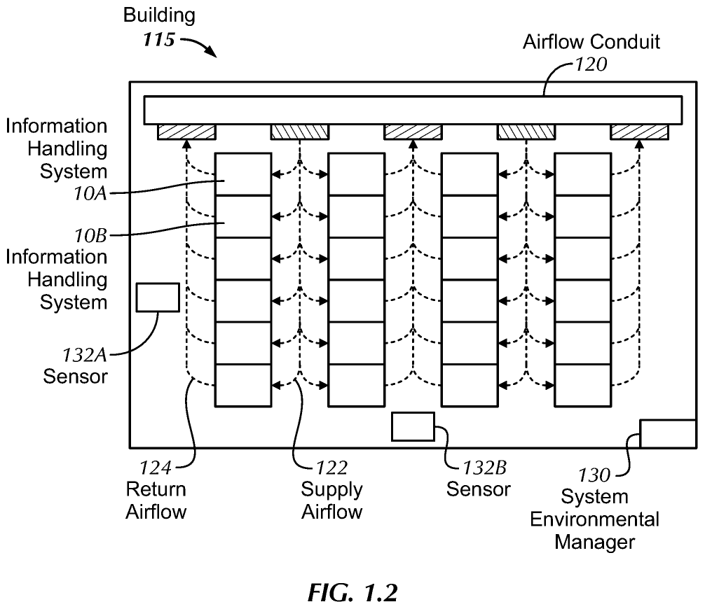

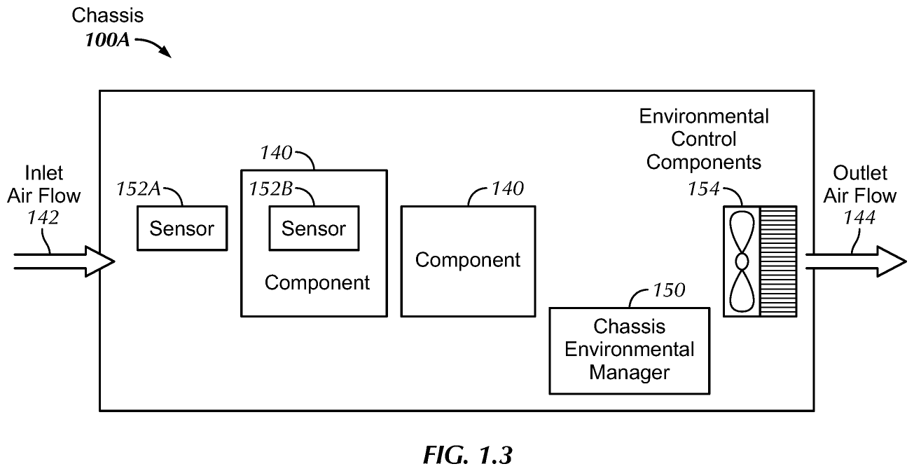

FIG. 1.1 shows an information handling system (10) in accordance with one or more embodiments of the invention. The system may include a frame (110) and any number of chassis (e.g., 100A, 100B, 100C).

As will be discussed in greater detail below, the information handling system (10) may include one or more sensors that can determine a temperature and/or relative humidity at different locations in the information handling system (10). In addition, each of the chassis (100A, 100B, 100C) includes one or more components whose useful service life is affected by the temperature and humidity conditions. The rate at which the component is aging is represented by an acceleration factor, which is based on the temperature and humidity experienced by the component. However, the sensors may not be positioned at every component. Thus, embodiments of the invention discussed below provide for a system and method to determine the acceleration factor at a component level based on the temperature and humidity data provided by the available sensors.

After determining the acceleration factor, an action from an action set is performed. This action set may include, but is not limited to: modifying an environmental condition, thereby adjusting the acceleration factor experienced by the component, notifying a user upon the acceleration factor exceeding a threshold value, and/or determining an estimate for a useful service life of the component based on the acceleration factor.

The frame (110) may be a mechanical structure that enables chassis to be positioned with respect to one another. For example, the frame (110) may be a rack mount enclosure that enables chassis to be disposed within it. The frame (110) may be implemented as other types of structures adapted to house, position, orient, and/or otherwise physically, mechanically, electrically, and/or thermally manage chassis (e.g., direct airflows to the chassis). By managing the chassis, the frame (110) may enable multiple chassis to be densely packed in space without negatively impacting the operation of the information handling system (10).

The frame may include a door (112). The door (112) may selectively provide access to the chassis (100A, 100B, 100C) within the information handling system (10). A chassis (e.g., 100A) may be a mechanical structure for housing components of an information handling system. For example, the chassis (100A, 100B, 100C) may be implemented as a rack mountable enclosure for housing components of an information handling system. The chassis may be adapted to be disposed within the frame (110) and/or utilize services provided by the frame (110) and/or other devices.

Any number of components may be disposed in each of the respective chassis (e.g., 100A, 100B, 100C). These components may be portions of computing devices that provide computer implemented services, discussed in greater detail below.

When the components provide computer implemented services, the components may generate heat. For example, the components may utilize electrical energy to perform computations and generate heat as a byproduct of performing the computations. If left unchecked, a buildup of heat within a chassis may cause temperatures of the components disposed within the chassis to exceed preferred ranges. In addition, the temperature of the air affects the relative humidity in the air. Assuming no change to the absolute humidity, the relative humidity is inversely proportional to the temperature (i.e., hotter air can hold more moisture).

The preferred ranges may include a nominal range in which the components respectively operate: (i) without detriment and/or (ii) are likely to be able to continue to operate through a predetermined service life of a component. Consequently, it may be desirable to maintain the temperature and/or relative humidity of the respective components. In doing so, the acceleration factor of the respective components may be kept below a threshold value thereby increasing the likelihood that the component continues to operate through the predetermined service life.

When a component operates under conditions that cause the acceleration factor to be above the threshold value, the service life of the component may be reduced (relative to the expected service life of the component when operating below the threshold value), the component may not be able to perform optimally (e.g., reduced ability to provide computations, higher likelihood of error introduced into computations, etc.), and/or the component may be more likely to unexpectedly fail. The component may be subject to other undesirable behavior when operating above the threshold value without departing from the invention.

To operate components under the threshold value of acceleration factor, the chassis may include air exchanges (e.g., 102). An air exchange may be one or more openings in an exterior of a chassis that enables the chassis to exchange gases with an ambient environment. For example, a chassis may utilize air exchanges to (i) vent hot gases and (ii) intake cool gases. By doing so, the temperature of the gases within the chassis may be reduced. Consequently, the temperatures of components within the chassis may be reduced by utilizing the cooler gases taken into the chassis via an air exchange.

However, providing cooler gases may be problematic. As discussed above, relative humidity is inversely proportional to temperature. Thus, cooling the gases raises the relative humidity, assuming no change in absolute humidity. The increase in relative humidity may (under certain conditions) condense resulting in water (even at low levels) being disposed on the surfaces of the chassis (100A, 100B, 100C) and/or components. For example, when gases are taken into the chassis via an air exchange (102), water vapor may condense onto the surface of the air exchanger (102).

When water is disposed on the surface of the chassis (100A, 100B, 100C) and/or components (even at very small levels), the water may chemically react forming corrosion. Further, chemicals disposed on the surface may absorb the moisture in the air to form a solution that may cause corrosion (e.g., through deliquescence). The aforementioned reactions with the condensed water may damage the chassis (100A, 100B, 100C), generate corrosion products that may circulate throughout the chassis, and/or damage the components within the chassis (100A, 100B, 100C) or otherwise cause them to operate in an undesirable manner. As may be seen, an increase in relative humidity may cause the acceleration factor to increase, even though the temperature has decreased. To address the above and/or other potential issues, embodiments of the invention may provide methods, devices, and systems that determine and adjust the acceleration factor at a component level.

In one or more embodiments of the invention, managing the acceleration factor may be handled by an information handling system environmental manager (119) that may be a computing device programmed to: (i) determine the acceleration factor of the components and (ii) perform an action from an action set based on the acceleration factor.

To decide which action to perform, the information handling system environmental manager (119) may obtain and/or be provided information regarding the environmental conditions (e.g., temperatures and relative humidity) within each of the chassis. For example, the system information system environmental manager (119) may be operably connected to environmental managers of each of the chassis via any combination of wired and/or wireless networks. In another embodiment, the information handling system environmental manager (119) may be located within a chassis. In another embodiment, the information handling system environmental manager (119) may be located within the frame (110) but not on the door (112). In another embodiment, the information handling system environmental manager (119) may be located external to the IHS (or the building in which the IHS is located (see e.g., FIG. 1.2). Those skilled in the art will appreciate that, in another embodiment, the information handling system environmental manager (119) may be located in any other location without departing from the invention. Further, while only one information handling system environmental manager (119) is shown, there may be multiple information handling system environmental managers, where each information handling system environmental manager is associated with one or more IHSs.

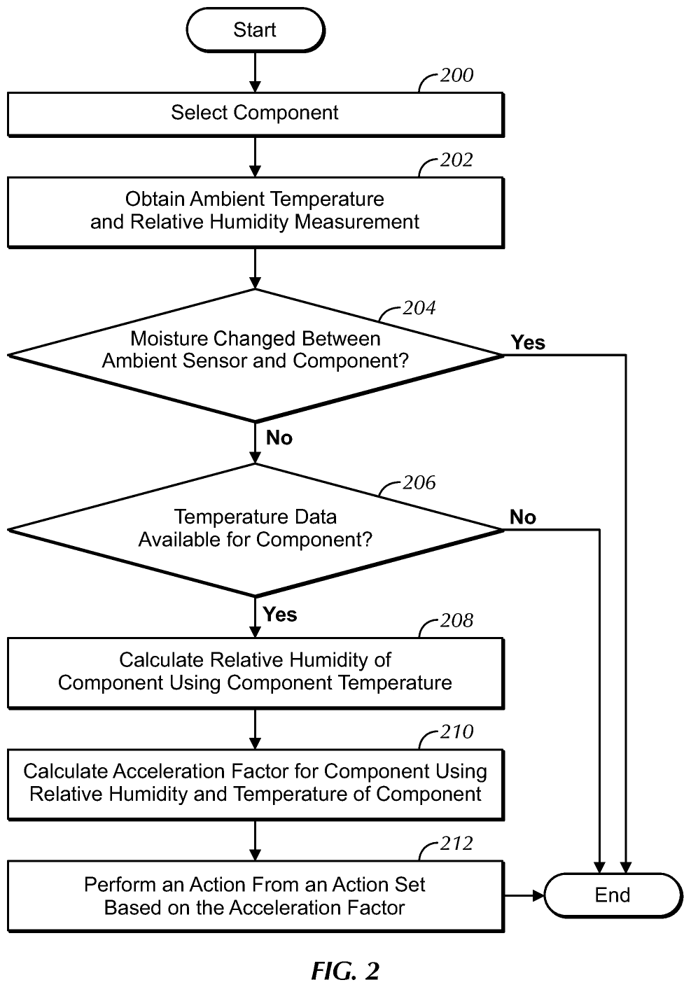

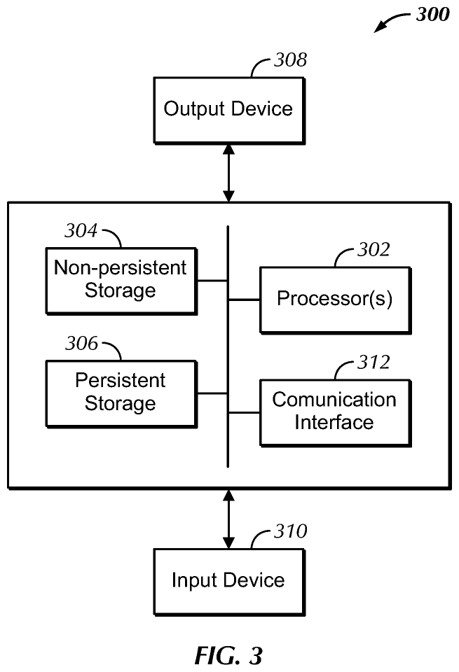

Continuing with the discussion of FIG. 1.1, the information handling system environmental manager (119) may be implemented using a computing device. For additional details regarding computing devices, refer to FIG. 3. The information handling system environmental manager (119) may perform all, or a portion, of the method illustrated in FIG. 2 while providing its functionality.

In one or more embodiments of the invention, the information handling system environmental manager (119) may be implemented using a hardware device including circuitry. The information handling system environmental manager (119) may be implemented using, for example, a digital signal processor, a field programmable gate array, or an application specific integrated circuit. The information handling system environmental manager (119) may be implemented using other types of hardware devices without departing from the invention.

In one or more embodiments of the invention, the information handling system environmental manager (119) is implemented using computing code stored on a persistent storage that when executed by a processor performs all, or a portion, of the functionality of the information handling system environmental manager (119). The processor may be a hardware processor including circuitry such as, for example, a central processing unit or a microcontroller. The processor may be other types of hardware devices for processing digital information without departing from the invention.

To further clarify the environments in which acceleration factors may arise, a diagram of an environment in which chassis of IHSs may reside is illustrated in FIG. 1.2 and a diagram of a chassis is provided in FIG. 1.3. However, it should be appreciated that IHSs may also reside individually and/or in areas without systems or devices capable of conditioning the air.

Turning to FIG. 1.2, FIG. 1.2 shows a top view diagram of a building (115) in which chassis of IHSs may reside in accordance with one or more embodiments of the invention. The building (115) may house a data center (e.g., an aggregation of information handling systems) that includes any number of information handling systems (e.g., 10A, 10B). The information handling systems may include chassis which may need to take in and exhaust gases for temperature regulation purposes due to heat generation by components disposed in the chassis.

To facilitate gas management within the building (115), the information handling systems may be organized into rows (or other groupings of information handling systems). In FIG. 1.2, the rows of information handling systems extend from top to bottom along the page. To enable gases to be provided to the information handling systems (e.g., for temperature regulation purposes), an airflow conduit (120) may be disposed within the building. The airflow conduit (120) may provide supply airflow (122) and take in a return airflow (124). These airflows are illustrated as arrows having dashed tails.

The supply airflow (122) may be at a lower temperature than the return airflow (124). Consequently, when information handling systems obtain portions of the supply airflow (122), the information handling systems may be able to utilize the supply airflow (122) to cool components disposed within the chassis of the information handling systems. For example, gases from the supply airflow (122) may be passed by components disposed within chassis of information handling systems that are at elevated temperatures. The gases may be at a lower temperature than the components. Consequently, thermal exchange between the gases and the components may decrease the temperature of the components.

After utilizing the gases from the supply airflow (122), the information handling systems may exhaust the gases as the return airflow (124). After being exhausted from the information handling systems, the return airflow (124) may be obtained by the airflow conduit (120), cooled, and recirculated as the supply airflow (122). Alternatively, the return airflow (124) may be exhausted outside of the building (115).

In addition to cooling the return airflow (124), the airflow conduit (120) may be capable of obtaining gases from other areas (e.g., outside of the building), reducing the humidity level of an airflow, and/or otherwise conditioning gases for use by information handling systems and/or other devices. Further, the airflow conduit (120) may exhaust the return airflow (124) and obtain air from other areas (e.g., outside of the building) to provide the supply airflow (122) without providing any conditioning to the air.

To manage the aforementioned process, a system environmental manager (130) may be disposed within the building (115) or at other locations. The system environmental manager (130) may be a computing device programmed to (i) obtain information regarding the operation of the information handling systems and (ii) set the operating points of the airflow conduit (120). By doing so, the system environmental manager (130) may cause the airflow conduit (120) to provide gases to the information handling systems having a temperature and/or relative humidity level that may better enable the information handling systems to regulate their respective environmental conditions within the chassis of the respective information handling systems. However, conditioning the supply airflow (122) may utilize large amounts of energy.

The airflow conduit (120) may include functionality to granularly, or at a macro level, modify the temperature and/or humidity level of the supply airflow (122). Consequently, different information handling systems (or groups thereof) may receive different supply airflows (e.g., 122) having different characteristics (e.g., different temperatures and/or humidity levels, different sources, etc.).

Conditioning the return airflow (124) or gases obtained from outside of the building (115) may be costly, consume large amounts of electricity, or may otherwise be undesirable. To reduce these costs, the system environmental manager (130) may set the operating point (e.g., desired temperature/humidity levels of different portions of the supply airflow (122)) of the airflow conduit (120) to only provide the minimum necessary characteristics required by each of the IHSs so that it meets is service life goals. By doing so, the cost of providing the supply airflow (122) having characteristics required to meet the environmental requirements of the chassis of the information handling systems may be reduced.

To decide how to set the operating points of the airflow conduit (120), the system environmental manager (130) may obtain and/or be provided information regarding the environmental conditions (e.g., temperatures, relative humidity levels) within each of the chassis. For example, the system environmental manager (130) may be operably connected to environmental managers of each of the chassis and/or the airflow conduit (120) via any combination of wired and/or wireless networks. The respective environmental managers of the chassis may provide such information to the system environmental manager (130) and/or service requests regarding the operating points of the airflow conduit (120) via the operable connections.

In addition to, or as an alternative to the above, the system environmental manager (130) may obtain and/or be provided information regarding the environmental conditions (e.g., temperatures, relative humidity levels) via any number of sensors (e.g., 132A, 132B) positioned at one or more locations in the building (115). For example, the system environmental manager (130) may be operably connected to sensors (132) via any combination of wired and/or wireless networks. Further, the system environmental manager (130) may obtain and/or be provided information regarding the environmental conditions (e.g., temperatures, relative humidity levels) via sources outside the building (115) and/or control of the system environmental manager (130) that provides environmental conditions for an area at or near the building (115) (e.g., weather data). The system environmental manager (130) may be located in any location within the building (115) or external to the building. Further, there may be one or more system environmental managers (130), where each system environmental manager (130) is associated with one or more buildings.

Continuing with the discussion of FIG. 1.2, the system environmental manager (130) may be implemented using a computing device. For additional details regarding computing devices, refer to FIG. 3. The system environmental manager (130) may perform all, or a portion, of the method illustrated in FIG. 2 while providing its functionality.

In one or more embodiments of the invention, the system environmental manager (130) may be implemented using a hardware device including circuitry. The information system environmental manager (130) may be implemented using, for example, a digital signal processor, a field programmable gate array, or an application specific integrated circuit. The system environmental manager (130) may be implemented using other types of hardware devices without departing from the invention.

In one or more embodiments of the invention, the system environmental manager (130) is implemented using computing code stored on a persistent storage that when executed by a processor performs all, or a portion, of the functionality of the system environmental manager (130). The processor may be a hardware processor including circuitry such as, for example, a central processing unit or a microcontroller. The processor may be other types of hardware devices for processing digital information without departing from the invention.

Turning to FIG. 1.3, FIG. 1.3 shows a diagram of a chassis (100A) in accordance with one or more embodiments of the invention. A chassis may be a portion of an IHS and/or house all, or a portion, of an IHS. An information handling system may include a computing device that provides any number of services (e.g., computing implemented services). To provide services, the computing device may utilize computing resources provided by components (140). The components (140) may include, for example, processors, memory modules, storage devices, special purpose hardware, and/or other types of physical components that contribute to the operation of the computing device. For additional details regarding computing devices, refer to FIG. 3.

Because the computing device uses components (140) to provide services, the ability of the computing device to provide services is limited based on the number and/or quantity of computing devices that may be disposed within the chassis. For example, by adding additional processors, memory modules, and/or special purpose hardware devices, the computing device may be provided with additional computing resources which it may be used to provide services. Consequently, large number of computing components that each, respectively, generate heat may be disposed within the chassis.

To maintain the temperatures of the components (140) (and/or other types of components) within a nominal range, gases may be taken in as an inlet air flow (142). The gases may be passed by the components (140) to exchange heat with them. The heated gases may then be expelled out as an outlet air flow (144).

However, by taking in and expelling gases used for cooling purposes, the inlet air flow (142), other portions of the chassis (100A) and/or components (140) disposed within the chassis (100A) may be subject to degradation due to temperature and relative humidity conditions. For example, as discussed above, the temperature and relative humidity of the gases may increase the acceleration factor.

For example, the computing device may have a service life during which it is expected that the computing device will be likely to provide its functionality. However, changes in the structure and/or electrical properties of these components due to exposure to humidity and/or elevated temperatures may cause the components to prematurely fail ahead of the service life being met.

To manage the internal environment of the chassis, the chassis (100A) may include a chassis environmental manager (150). The chassis environmental manager (150) may provide environmental management services. Environmental management services may include: (i) obtaining information regarding the temperature and relative humidity of an ambient environment outside of the chassis (100A), (ii) determining or obtaining information regarding the temperature of the component (140), (iii) determining the relative humidity of the component (140) based on the ambient temperature, ambient relative humidity, and component temperature, (iv) determining the acceleration factor of the component (140) based on the component temperature and the component relative humidity, and (v) performing an action from an action set based on the acceleration factor. The action set may include: modifying an environmental condition, thereby adjusting the acceleration factor experienced by the component, notifying a user upon the acceleration factor exceeding a threshold value, or determining an estimate for a useful service life of the component based on the acceleration factor.

By doing so, embodiments of the invention may reduce the acceleration factor of chassis and/or components within chassis. By doing so, the computing devices disposed within chassis (e.g., 100A) may be more likely to meet their respective service life goals and/or require fewer repairs during their respective service lives (e.g., due to reduced numbers of premature failures due to corrosion).

While illustrated in FIG. 1.3 as a physical structure, the chassis environmental manager (150) may be implemented as a logical entity (e.g., a program executing using the computing components (140)). For example, a computing device disposed in the chassis (or other locations) may host an application (e.g., executable computer instructions being executed by a processor) that provides the functionality of the chassis environmental manager (150).

To enable the chassis environmental manager (150) to provide its functionality, the chassis (100A) may include one or more sensors (e.g., 152A, 152B). These sensors may obtain data indicative of the temperature within the chassis (e.g., at sensor 152A) or, more specifically, the component temperature of a component (140) (e.g., at sensor 152B). These sensors are operably connected to the chassis environmental manager (150). Any number of sensors may be disposed at any number of locations throughout the chassis (100A).

In some embodiments of the invention, the functionality of a temperature detector may be provided by, in all or in part, the components (140). For example, the components (140) may include functionality to report their respective temperatures of the internal environment of the chassis (100A).

The chassis (100A) may also include environmental control components (154). The environmental control components (154) may include physical devices that include functionality to modify characteristics (e.g., temperature, relative humidity, airflow rates/directions) of the internal environment (104) of the chassis (100A). The chassis (100A) may include any number of environmental control components disposed at any number of locations within the chassis.

For example, the environmental control components (154) may include gas movers such as fans. The fans may be able to modify the rate of gases being taken into and expelled from the chassis (100A). The rate of intake and exhaust of gases may cause an airflow to be generated within the internal environment. The airflow may be used to modify the rate of thermal exchange between the components (140) and the internal environment (e.g., an environment proximate to the components (140)).

As an additional example, the environmental control components (154) may include components that are not disposed in the chassis (not shown). For example, the environmental control components may include an airflow conduit discussed with respect to FIG. 1.2. These external components may be used in conjunction with the environment control components disposed within the chassis to manage the temperature and/or relative humidity levels throughout the internal environment of the chassis as well as those of gases as they are taken into and/or expelled by the chassis (100A). However, the use of airflow conditioners or other macro-level airflow conditioners may be avoided due to the lower level of discrimination available for conditioning gases using such devices.

The chassis (100A) may include any number and type of environmental control components without departing from the invention. Any of the environmental control components may be implemented using physical devices operably connected to and/or controllable by the chassis environmental manager (150) and/or a system environmental manager (e.g., 130, FIG. 1.2) (alone or in combination). Any number of chassis environmental managers and system environmental managers may cooperatively operate to control the temperature and/or relative humidity to control the acceleration factor of components (140) within the chassis and/or manage the thermal load generated by the components (140).

To cooperatively operate, the chassis environmental managers, the information handling system environmental managers, and the system environmental managers may be operably connected to each another (e.g., via wired and/or wireless networks). The aforementioned components may share information with one another (e.g., sensor data, operating set points of different environmental control components, etc.). These components may implement any type of model for controlling and/or delegating control of the system for temperature, relative humidity, and/or acceleration factor management purposes. When providing their respective functionalities, these components may perform all, or a portion, of the method illustrated in FIG. 2. Additionally, any capability and functionality described herein with respect to any specific environmental manager may be performed by any of the disclosed environmental managers (i.e., the chassis environmental managers, the information handling system environmental managers, and the system environmental managers). Any of these components may be implemented using a computing device. For additional details regarding computing devices, refer to FIG. 3.

While the chassis (100A) of FIG. 1.3 has been illustrated as including a limited number of specific components, a chassis in accordance with one or more embodiments of the invention may include additional, fewer, and/or different components without departing from the invention. Additionally, while the chassis (100A) is illustrated as having a specific form factor (e.g., rack mount), a chassis in accordance with embodiments of the invention may have different form factors without departing from the invention.

As discussed above, the chassis environmental manager (150) may provide environmental management services. Environmental management services may reduce the likelihood that IHSs fail prematurely (e.g., prior to meeting service life goals) due to temperature and relative humidity conditions.

In one or more embodiments of the invention, the chassis environmental manager (150) is implemented using distributed computing devices. As used herein, a distributed computing device refers to functionality provided by a logical device that utilizes the computing resources of one or more separate and/or distinct computing devices. For example, in one or more embodiments of the invention, the chassis environmental manager (150) is implemented using distributed devices that include components distributed across any number of separate and/or distinct computing devices. In such a scenario, the functionality of the chassis environmental manager (150) may be performed by multiple, different computing devices without departing from the invention.

The chassis environmental manager (150) may manage environmental control components that may be used to control the characteristics (e.g., temperature, humidity level, airflow rates, etc.) of the environment within the chassis (100A). To manage them, the chassis environmental manager (150) may obtain information regarding the temperature and relative humidity of environment outside of the chassis (100A) or the information handling system (i.e., ambient temperature and ambient relative humidity). Further, the chassis environmental manager (150) may obtain information regarding the temperature of a component (140) either directly from a sensor of the component or by determining the temperature of a component based on other information. For example, the chassis environmental manager (150) may determine the component temperature by (i) obtaining information regarding the temperature of a second component and estimating the component temperature based on the temperature of the second component, and/or (ii) estimating the component temperature based on data indicative of power usage of the component (e.g., via a lookup table, experimental results, etc.).

In addition, the chassis environmental manager (150) may determine the relative humidity of the component (i.e., the component humidity) based on the component temperature, the ambient temperature, and the ambient humidity. Next, the chassis environmental manager (150) may determine the acceleration factor for the component based on the component humidity and the component temperature. With the acceleration factor, the chassis environmental manager (150) may perform an action from an action set based on the acceleration factor. This action set may include: modifying an environmental condition, thereby adjusting the acceleration factor experienced by the component, notifying a user upon the acceleration factor exceeding a threshold value, or determining an estimate for a useful service life of the component based on the acceleration factor.

Further, the chassis environmental manager (150) may store (e.g., in a memory module contained within the chassis environmental manager (150) or at any other suitable location) the acceleration factor (i.e., continuously or at discrete intervals) to create a historical information of acceleration factors for a component over time. This historical information may be used to (i) determine a total acceleration factor for the component, (ii) determine a useful service life for the component, (iii) base future determinations of acceleration factors on the historical information, and/or (iv) use the historical information to form predictive models to estimate future acceleration factors of components.

To provide the above noted functionality of the chassis environmental manager (150), the chassis environmental manager (150) may perform all, or a portion, of the method illustrated in FIG. 2.

In one or more embodiments of the invention, the chassis environmental manager (150) may be implemented using a hardware device including circuitry. The chassis environmental manager (150) may be implemented using, for example, a digital signal processor, a field programmable gate array, or an application specific integrated circuit. The chassis environmental manager (150) may be implemented using other types of hardware devices without departing from the invention.

In one or more embodiments of the invention, chassis environmental manager (150) is implemented using computing code stored on a persistent storage that when executed by a processor performs all, or a portion, of the functionality of the chassis environmental manager (150). The processor may be a hardware processor including circuitry such as, for example, a central processing unit or a microcontroller. The processor may be other types of hardware devices for processing digital information without departing from the invention.

While the chassis environmental manager (150) of FIG. 1.3 has been described and illustrated as including a limited number of specific components for the sake of brevity, an environmental manager in accordance with embodiments of the invention may include additional, fewer, and/or different components than those illustrated in FIG. 1.3 without departing from the invention.

Further, any of the components may be implemented as a service spanning multiple devices. For example, multiple computing devices housed in multiple chassis may each run respective instances of the one in the chassis environmental manager (150). Each of these instances may communicate and cooperate to provide the functionality of the chassis environmental manager (150).

As discussed above with respect to FIG. 1.3, the chassis environmental manager (150) may provide environmental management services. FIG. 2 illustrates a method that may be performed by the chassis environmental manager (150) of FIG. 1.3 (or any other environmental manager discussed above) when providing environmental management services.

FIG. 2 shows a flowchart of a method in accordance with one or more embodiments of the invention. The method depicted in FIG. 2 may be used to manage a chassis environment in accordance with one or more embodiments of the invention. The method shown in FIG. 2 may be performed by, for example, a chassis environmental manager (e.g., 150, FIG. 1.3). Other components of the system illustrated in FIGS. 1.1-1.3 may perform all, or a portion, of the method of FIG. 2 without departing from the invention.

While FIG. 2 is illustrated as a series of steps, any of the steps may be omitted, performed in a different order, additional steps may be included, and/or any or all of the steps may be performed in a parallel and/or partially overlapping manner without departing from the invention.

In step 200, a component is selected. The component may be, for example, a computing component disposed within a chassis. The component may be selected based on a listing or other data structure of components for which an environmental manager is to provide environmental management services. The component may be selected using any other mechanism without departing from the invention.

In step 202, an ambient temperature and an ambient relative humidity associated with an ambient environment is obtained. The ambient temperature and/or the ambient relative humidity associated with the ambient environment may be monitored using, for example, one or more sensors positioned in the ambient environment (i.e., outside of a chassis). The monitoring may be performed for any duration of time.

As described above, the sensor may be positioned on an information handling system, in a position near the information handling system (e.g., in the same room or building), or somewhere else in the ambient environment (e.g., as part of a weather tracking service or other environmental condition monitoring system). Further, the ambient temperature and ambient humidity values may be obtained and stored separately as two values, or they may be combined into a single value, known as a dew point value.

In step 204, it is determined whether a moisture level is changed (i.e., moisture added or removed) in the air in a space between the sensor providing measurements for the ambient relative humidity and the selected component. For example, this determination is input by a user and is based on a determination of the position of the sensor providing the ambient humidity relative to the selected component (e.g., distance from the component), or based on whether the selected component and the sensor are in the same controlled environment.

If it is determined that a moisture level is not changed in the air in a space between the sensor and the selected component, the method may proceed to step 206. If not, and it is determined that a moisture level is changed in the air between the sensor and the selected component, then the method may end following step 204.

In step 206, it is determined whether temperature data is available for the selected component. For example, the selected component may include a temperature sensor integrated into the component. If the component includes an integrated temperature sensor, the component may provide the component temperature associated with the component to an environmental manager. Further, the temperature data may be determined from other information. For example, the component temperature may be determined by (i) obtaining information regarding the temperature of a second component and estimating the component temperature based on the temperature of the second component, and/or (ii) estimating the component temperature based on data indicative of power usage of the component (e.g., via a lookup table, experimental results, etc.). Other methods for determining the temperature may be used without departing from the invention.

If it is determined that the component temperature may be determined, the method may proceed to step 208. If not, and it is determined that the component temperature cannot be determined, either directly or indirectly, then the method may end following step 206.

In step 208, a relative humidity of the selected component is calculated based on the component temperature determined in step 206 and the ambient temperature and ambient humidity obtained in step 202. Further, in embodiments in which the ambient temperature and ambient humidity are combined into a dew point value, the component relative humidity is calculated using the component temperature and the dew point value. Because it was previously determined in step 204 that the moisture level did not changed between the sensor and the selected component, the relative humidity of the selected component may be calculated. The calculation of the component humidity may be performed using the Antoine equation for calculating the vapor pressure of water provided below in Equation 1, where A, B, and C are constants, T is the component temperature and Pₛₐₜ(T) is the vapor pressure.

$${log}_{10} {P}_{s a t} ( T ) = A - \frac{B}{C + T} \qquad ( Eq . 1 )$$

In step 210, an acceleration factor of the selected component is calculated based on the component humidity and the component temperature. The acceleration factor is a measurement that provides how fast a component is aging compared to a baseline. Before calculating the acceleration factor, a baseline is established. This baseline may be established using temperature and humidity values under conditions that are ideal for component longevity, typical conditions experienced by components, or any other baseline. After establishing a baseline, the acceleration factor is calculated using the Arrhenius-Peck equation provided below in Equation 2, where AF is the acceleration factor, R₁ is the baseline relative humidity, R₂ is the component humidity, Eₐ is a baseline activation energy, K is the Boltzmann constant, T₁ is the baseline temperature, and T₂ is the component temperature.

$$A F = {( \frac{{R}_{1}}{{R}_{2}} )}^{- 2.66} * [ {e}^{\frac{{E}_{a}}{K} * ( \frac{1}{{T}_{1}} - \frac{1}{{T}_{2}} )} ] \qquad ( Eq . 2 )$$

Both the calculations for component humidity and acceleration factor are computationally efficient. As such, the computational burden for calculating the acceleration factor is low, which in turn enables the acceleration factor to be calculated in intervals considered real-time. The calculated acceleration factor values may be stored in a storage module, thereby providing a historical log of acceleration factors. In addition, the historical log of acceleration factors may be utilized to provide a single acceleration factor for the selected component which may be adjusted as additional acceleration factor values are calculated. Further, the acceleration factor values may be based, in part, on previously calculated acceleration factors. In addition, real-time tracking of the acceleration factor may enable certain actions to be performed that adjust the acceleration factor.

In step 212, an action from an action set is performed based on the acceleration factor. The action set may include: modifying an environmental condition, thereby adjusting the acceleration factor experienced by the component, notifying a user upon the acceleration factor exceeding a threshold value, or determining an estimate for a useful service life of the component based on the acceleration factor. Determining an estimate may include building a predictive model using the acceleration factors. These predictions may be used to ascertain when the acceleration factor of the component indicates a premature failure (e.g., whether the component will fail prior to meeting service life goals). If the component will not meet is service life goals based on the prediction, the corrosion risk may indicate the premature failure of the component.

The method may end following step 212.

Embodiments of the invention may be implemented using a computing device. FIG. 3 shows a diagram of a computing device in accordance with one or more embodiments of the invention. The computing device (300) may include one or more computer processors (302), non-persistent storage (304) (e.g., volatile memory, such as random access memory (RAM), cache memory), persistent storage (306) (e.g., a hard disk, an optical drive such as a compact disk (CD) drive or digital versatile disk (DVD) drive, a flash memory, etc.), a communication interface (312) (e.g., Bluetooth interface, infrared interface, network interface, optical interface, etc.), input devices (310), output devices (308), and numerous other elements (not shown) and functionalities. Each of these components is described below.

In one embodiment of the invention, the computer processor(s) (302) may be an integrated circuit for processing instructions. For example, the computer processor(s) may be one or more cores or micro-cores of a processor. The computing device (300) may also include one or more input devices (310), such as a touchscreen, keyboard, mouse, microphone, touchpad, electronic pen, or any other type of input device. Further, the communication interface (312) may include an integrated circuit for connecting the computing device (300) to a network (not shown) (e.g., a local area network (LAN), a wide area network (WAN) such as the Internet, mobile network, or any other type of network) and/or to another device, such as another computing device.

In one embodiment of the invention, the computing device (300) may include one or more output devices (308), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (302), non-persistent storage (304), and persistent storage (306). Many different types of computing devices exist, and the aforementioned input and output device(s) may take other forms.

Embodiments of the invention may provide an improved method for managing components of an information handling system. Specifically, embodiments of the invention may provide a method and device for managing environmental conditions that may cause components of an information handling system to fail. To do so, embodiments of the invention may provide systems and methods that calculate an acceleration factor and perform an action from an action set based on the acceleration factor. By doing so, acceleration factors of components may be monitored and managed, thereby increasing the service lives of components and the reliability of information handling systems.

Thus, embodiments of the invention may address the problem of providing reliability for components in information handling systems. Specifically, embodiments of the invention may provide a method of managing environmental conditions that affect the acceleration factor of components.

The problems discussed above should be understood as being examples of problems solved by embodiments of the invention disclosed herein and the invention should not be limited to solving the same/similar problems. The disclosed invention is broadly applicable to address a range of problems beyond those discussed herein.

One or more embodiments of the invention may be implemented using instructions executed by one or more processors of the computing device (300). Further, such instructions may correspond to computer readable instructions that are stored on one or more non-transitory computer readable mediums.

While the invention has been described above with respect to a limited number of embodiments, those skilled in the art, having the benefit of this disclosure, will appreciate that other embodiments may be devised which do not depart from the scope of the invention as disclosed herein. Accordingly, the scope of the invention should be limited only by the attached claims.

What is claimed is:

1. A method for managing environmental conditions of an information handling system, comprising:
obtaining an ambient temperature of an environment proximate to the information handling system;
obtaining an ambient humidity of the environment;
determining a component temperature of a component in the information handling system;
determining a component humidity of the component based on the component temperature, the ambient temperature, and the ambient humidity;
determining an acceleration factor for the component based on the component humidity and the component temperature; and
performing an action from an action set based on the acceleration factor.

2. The method of claim 1, further comprising:
determining that a moisture level in a volume between a sensor measuring ambient humidity data and the component is unchanged, wherein the determination is made before determining the component humidity.

3. The method of claim 1, wherein determining the component temperature data comprises obtaining the component temperature from a sensor of the component.

4. The method of claim 1, wherein determining the component temperature comprises estimating the component temperature based on temperature data obtained from at least one sensor proximate to the component.

5. The method of claim 1, wherein determining the component temperature comprises estimating the component temperature based on data indicative of power used by the component.

6. The method of claim 1, further comprising:
storing, in a memory module, the acceleration factor to create a historical information of acceleration factors for the component over time; and
wherein determining the acceleration factor is also based on the historical information of acceleration factors.

7. The method of claim 1, wherein performing the action comprises modifying an environmental condition to adjust at least one of the component temperature or the component humidity.

8. The method of claim 1, wherein performing the action comprises notifying a user upon the acceleration factor exceeding a threshold value.

9. The method of claim 1, further comprising:
wherein performing the action comprises determining an estimate for a useful service life of the component based on the acceleration factor; and
notifying a user of the estimate upon the estimate reaching a threshold value.

10. An information handling system comprising:
a component;
a first ambient sensor configured to measure an ambient temperature of an environment proximate to the information handling system;
a second ambient sensor configured to measure an ambient humidity of the environment;
a component sensor configured to measure a component temperature of the component; and
a processor programmed to:
obtain the ambient temperature from the first ambient sensor;
obtain the ambient humidity from the second ambient sensor;
determine a component temperature of the component;
determine a component humidity of the component based on the component temperature, the ambient temperature, and the ambient humidity;
determine an acceleration factor for the component based on the component humidity and the component temperature; and
perform an action from an action set based on the acceleration factor.

11. The information handling system of claim 10, wherein the processor is further programmed to:
determine that a moisture level in a volume between a sensor measuring ambient humidity data and the component is unchanged, wherein the determination is made before determining the component humidity.

12. The information handling system of claim 10, wherein the processor is further programmed to:
determine an estimate for a useful service life of the component based on the acceleration factor.

13. The information handling system of claim 10, wherein the processor is further programmed to:
store, in a memory module, the acceleration factor to create a log of acceleration factors for the component over time.

14. The information handling system of claim 10, further comprising:
a fan configured to control airflow through the information handling system, and wherein performing the action comprises modifying an operation of the fan.

15. The information handling system of claim 10, wherein performing the action comprises notifying a user upon the acceleration factor exceeding a threshold value.

16. A non-transitory computer readable medium comprising computer readable program code, which when executed by a computer processor enables the computer processor to perform a method for managing environmental conditions of an information handling system, the method comprising:
obtaining an ambient temperature of an environment proximate to the information handling system;
obtaining an ambient humidity of the environment;
determining a component temperature of a component in the information handling system;
determining a component humidity of the component based on the component temperature, the ambient temperature, and the ambient humidity;
determining an acceleration factor for the component based on the component humidity and the component temperature; and
performing an action from an action set based on the acceleration factor.

17. The non-transitory computer readable medium of claim 16, wherein determining the component temperature comprises estimating the component temperature based on temperature data obtained from at least one sensor proximate to the component.

18. The non-transitory computer readable medium of claim 16, wherein determining the component temperature comprises estimating the component temperature based on data indicative of power used by the component.

19. The non-transitory computer readable medium of claim 16, wherein performing the action comprises modifying an environmental condition to adjust at least one of the component temperature or the component humidity.

20. The non-transitory computer readable medium of claim 16, wherein the method further comprises:
wherein performing the action comprises determining an estimate for a useful service life of the component based on the acceleration factor; and
notifying a user of the estimate upon the estimate reaching a threshold value.
